(19) United States
(12) Patent Application Publication
(10) Pub. No.: US 2002/0180401 A1
(43) Pub. Date: Dec. 5, 2002

(54) Method and system for cooling a vehicle by controlling the engine speed of a vehicle

(76) Inventor: Ajith Kuttannair Kumar, Erie, PA (US)

Correspondence Address: Keith J. Murphy, Cantor Colburn LLP, 55 Griffin Road South, Bloomfield, CT, 06002, US

(21) Appl. No.: 10/016,158

(22) Filed: Dec. 10, 2001

Related U.S. Application Data
(60) Provisional application No. 60/294,683, filed on May 31, 2001.

(51) Int. Cl. H02P 1/24

(52) U.S. Cl. 318/727

(57) ABSTRACT

A system and method for cooling a vehicle by controlling the engine speed of a vehicle including a vehicle system, wherein the vehicle system includes a vehicle system component, an engine having an engine speed, an alternator and a blower having a blower speed and a controller, wherein the controller is communicated with the engine so as to control the engine speed and wherein the controller is communicated with the vehicle system component so as to be responsive to the temperature of the vehicle system component and wherein the method includes operating the vehicle system so as to cause the engine and the blower to operate, communicating a temperature signal from the vehicle component to the controller, comparing the temperature signal with a predetermined temperature threshold value so as to determine if the temperature signal exceeds the predetermined temperature threshold value and controlling the engine so as to cause the engine to operate at a predetermined engine operating speed.

### CROSS-REFERENCE TO RELATED APPLICATIONS

This application claims the benefits of U.S. provisional application No. 60/294,683, filed May 31, 2001 the contents of which are incorporated by reference herein in their entirety

### BACKGROUND OF THE INVENTION

The invention relates generally to a method and system for cooling a vehicle and in particular to a method and system for cooling a vehicle by controlling the engine speed of a vehicle so as to improve the fuel efficiency in vehicle cooling. Existing vehicles, such as locomotives, cool vehicle components (e.g., traction motors, rectifiers, traction inverters) using blowers. These blowers typically include induction motors that are connected to the diesel engine via an auxiliary alternator. During operation, the diesel engine powers the auxiliary alternator, which in turn, powers the induction motors which drive the blowers. Since these blowers are driven by induction motors, the blower speed is dependent on the frequency of the power input to the induction motors and thus responsive to the engine speed. Therefore, as a result of the induction motors being connected to an alternator that is being driven by the diesel engine, the diesel engine speed determines the speed of the induction motor, the blower and the amount of cooling air dispersed by the blower.

However, the engine speed on a locomotive may be determined based on various requirements. For example, when a locomotive is operating in motoring mode, the engine speed may be determined based on the horse power needed to operate the locomotive. Whereas when a locomotive is operating in dynamic braking mode, cooling requirements may dictate that the engine speed be above a certain speed so as to ensure that adequate cooling occurs. In regards to operating a locomotive in dynamic braking mode, existing systems make two assumptions in order to determine the amount of cooling needed. The first assumption is that the locomotive is in a steady state of operation (e.g., components have warmed-up) and the second assumption is that the locomotive is operating at the maximum worse case ambient conditions. Although these assumptions ensure adequate cooling for vehicle components, they often result in providing excessive and unnecessary cooling by maintaining engine speeds higher than is actually required. In addition, operating the engine alone typically equates to an increased amount of fuel consumption. Thus, these assumptions can lead to an increased and inefficient use of fuel due to blower loads and engine speed.

Therefore, a need remains for a method and system for cooling a vehicle by controlling the engine speed of a vehicle, wherein the method and system will improve vehicle fuel efficiency and ensure adequate cooling for vehicle components.

### SUMMARY OF THE INVENTION

A system for cooling a vehicle by controlling the engine speed of a vehicle comprising: a vehicle system, wherein the vehicle system includes a vehicle system component, an engine having an engine speed, an alternator and a blower having a blower speed; and a controller, wherein the controller is communicated with the engine so as to control the engine speed and wherein the controller is communicated with the vehicle system component so as to be responsive to the temperature of the vehicle system component.

In a vehicle having a vehicle system which includes an engine having an engine speed, a blower having a blower speed, a vehicle component and a controller, wherein the controller is communicated with the engine such that the engine speed is responsive to the controller and wherein the engine is communicated with the blower such that the blower speed is responsive to the engine speed, a method for cooling a vehicle by controlling the engine speed of the vehicle comprising: operating the vehicle system so as to cause the engine and the blower to operate; communicating a temperature signal from the vehicle component to the controller; comparing the temperature signal with a predetermined temperature threshold value so as to determine if the temperature signal exceeds the predetermined temperature threshold value; and controlling the engine so as to cause the engine to operate at a predetermined engine operating speed.

In a vehicle having a vehicle system which includes an engine having an engine speed, a blower having a blower speed, a vehicle component and a controller, wherein the controller is communicated with the engine such that the engine speed is responsive to the controller and wherein the engine is communicated with the blower such that the blower speed is responsive to the engine speed, a medium encoded with a machine-readable computer program code for controlling the engine speed of a vehicle, the medium including instructions for causing controller to implement the aforementioned method.

### BRIEF DESCRIPTION OF THE DRAWINGS

FIG. 1 is a schematic representation of a locomotive vehicle system having a system for cooling a vehicle by controlling the engine speed of a vehicle in accordance with an embodiment of the invention; and,

FIG. 2 is a flowchart describing a method for cooling a vehicle by controlling the engine speed of a vehicle in accordance with an embodiment of the invention.

### DETAILED DESCRIPTION OF THE INVENTION

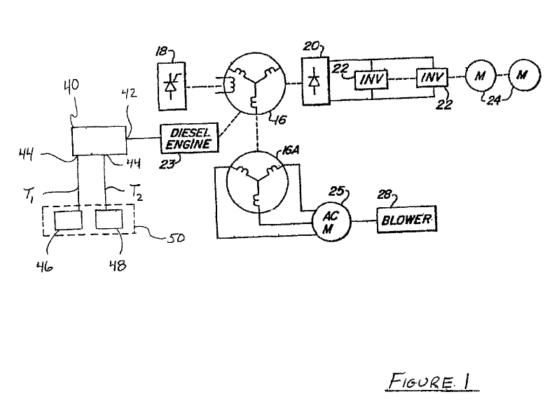

Referring to FIG. 1, a schematic representation of a locomotive vehicle system 1 having a system for controlling the engine speed of a vehicle in accordance with an embodiment of the invention is shown and includes an alternator 16, a diesel engine 23 capable of operating at least at two different speeds, a field excitation control device 18, a rectifying device 20, inverters 22 and AC traction motors 24. In addition, vehicle system 1 includes a blower 28, an induction motor 25, an auxiliary winding set 16A and a controller device 40, wherein controller device 40 preferably includes at least one controller output 42 and at least one controller input 44. Furthermore, vehicle system 1 includes a plurality of vehicle components 50 having a first vehicle system component 46 and a second vehicle system component 48.

In accordance with an embodiment of the invention, controller 40 is preferably disposed such that controller output 42 is communicated with diesel engine 23 and controller input 44 is communicated with plurality of vehicle components 50 so as to receive a temperature signal which includes a first temperature signal T₁ and a second temperature signal T₂, wherein the first temperature signal T₁ is responsive to the temperature of first vehicle system component 46 and wherein the second temperature signal T₂ is responsive to the temperature of second vehicle system component 48. In accordance with an embodiment of the invention, first temperature signal T₁ may relate to the semiconductor junction temperature of a device located in inverter 22. Also in accordance with an embodiment of the invention, other temperature signals such as second temperature signal T₂ may relate to the traction motor 24 temperature (e.g. stator and rotor temperatures). It is considered within the scope of the invention that other temperature signals related to other vehicle components 50 may be provided to controller device 40.

In accordance with an embodiment of the invention, the temperature signal (e.g. first temperature signal T₁ and a second temperature signal T₂) may be produced by temperature sensors directly communicated with vehicle components 50 and/or may be produce by temperature sensors disposed so as to be proximate to vehicle components 50. This would allow the direct temperature of the vehicle components 50 and the ambient temperature surrounding the vehicle components 50 to be measured and determined. It is also considered within the scope of the invention that the temperature signal may be calculated and/or predicted based on models implemented by controller device 40. In accordance with an embodiment of the invention, first temperature signal T1 and/or second temperature signal T2 may be determined using any method and/or device known in the art and suitable to the desired end purpose. Also, in accordance with an embodiment of the invention, first temperature signal T1 and/or second temperature signal T2 may, in part or in whole, be a function of the environment or characteristics of vehicle component 50, such as available cooling air, power dissipation, estimated heat sink temperature and motor temperature.

Controller output 42 is preferably communicated with diesel engine 23 so as to allow controller 40 to control the speed of diesel engine 23 in a manner responsive to the temperature of vehicle components 50. Alternator 16 is communicated with diesel engine 23, field excitation control device 18, rectifying device 20 and auxiliary winding set 16A. Inverters 22 are communicated with rectifying device 20 and AC traction motors 24. In addition, induction motor 25 is communicated with auxiliary winding set 16A and blower 28.

During operation, diesel engine 23 of locomotive vehicle system 1 drives alternator 16 which produces a power output signal. The power output signal produced by alternator 16 is applied to field excitation control device 18 and regulated in a manner well known in the prior art. In addition, the power output signal produced by alternator 16 is applied to a rectifying device 20 so as to produce a rectified power signal. The rectified power signal is applied to inverters 22 so as to convert the rectified power signal into a power signal having a variable frequency and a variable amplitude for application to AC traction motors 24. Furthermore, alternator 16 is communicated with auxiliary winding set 16A so as to drive auxiliary winding set 16A which produces an AC power signal. Auxiliary winding set 16A is communicated with induction motor 25 so as to drive induction motor 25. The AC power signal produce by auxiliary winding set 16A is applied to induction motor 25 so as to allow induction motor 25 to power and drive blower 28. Blower 28 provides cooling air to vehicle components such as rectifying device 20, inverters 22 and AC traction motors 24. Alternator 16 is a synchronous device which includes rotors that may be communicated with diesel engine 23 via an output shaft of diesel engine 23. Because of this the speed of blower 28 is responsive to the speed of diesel engine 23.

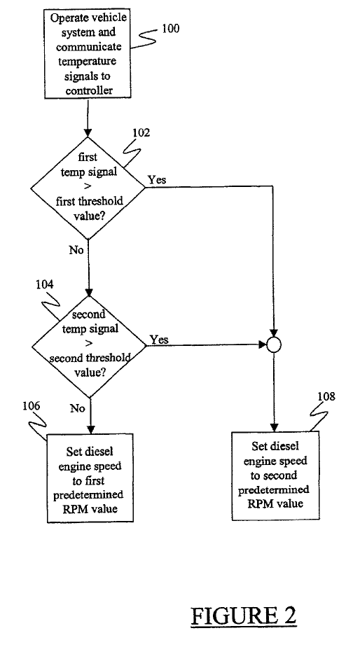

Referring to FIG. 1 and FIG. 2, as vehicle system 1 operates, first temperature signal T₁ and second temperature signal T₂ are communicated to controller input 44, as shown in step 100. In accordance with an embodiment of the invention, controller 40 performs a temperature comparison so as to compare temperature signal T₁ and second temperature signal T₂ with a predetermined temperature threshold value and adjusts the engine speed in a manner responsive to the temperature comparison. In accordance with an embodiment of the invention, predetermined temperature threshold value includes a first temperature threshold value and a second temperature threshold value. First temperature signal T₁ and second temperature signal T₂ are then compared with at least one predetermined temperature threshold value, represented here as first temperature threshold value and second temperature threshold value. Depending on the result of this comparison, controller 40 will control diesel engine 23 so as to cause diesel engine 23 to operate at a predetermined engine operating speed which includes a first predetermined engine operating speed and a second predetermined engine operating speed, wherein the first predetermined engine operating speed includes a first predetermined number of revolutions per minute (RPM) and the second predetermined engine operating speed includes a second predetermined number of revolutions per minute (RPM).

In accordance with an embodiment of the invention, first temperature signal T₁ is compared with first temperature threshold value to determine if first temperature signal T₁ exceeds the first temperature threshold value as in step 102. If first temperature signal T₁ is equal to or exceeds the first temperature threshold value, then controller 40 will instruct diesel engine 23 to run at or above a second predetermined engine operating speed having a second predetermined number of revolutions per minute (RPM) as in step 108. If first temperature signal T₁ does not exceed the first temperature threshold value, then second temperature signal T₂ will then be compared with a second temperature threshold value to determine if second temperature signal T₂ exceeds the second temperature threshold value as in step 104. If second temperature signal T₂ is equal to or exceeds the second temperature threshold value, then controller 40 will instruct diesel engine 23 to run at or above a second predetermined engine operating speed having a second predetermined number of revolutions per minute (RPM) as in step 108. If the second temperature signal T₂ does not exceed the second temperature threshold value, then controller 40 will instruct diesel engine 23 to run at a first predetermined engine operating speed having a first predetermined number of revolutions per minute (RPM) as in step 106. In this way, while diesel engine 23 is not operating in a mode which requires a high engine speed due to horse power needs, the engine speed of diesel engine 23 may be increased, decreased or maintained depending on specific vehicle component cooling needs.

In accordance with an embodiment of the invention, first predetermined engine operating speed and second predetermined engine operating speed is preferably determined in a manner responsive to the locomotive speed and/or breaking effort (force) and/or tractive effort (pulling force). However, it is considered within the scope of the invention that first predetermined engine operating speed and second predetermined engine operating speed may be any suitable engine operating speeds known in the art and suitable to the desired end purpose. It is considered within the scope of the invention that, although first predetermined engine operating speed and second predetermined engine operating speed are expressed hereinabove as number of RPM's, any suitable parameter used to measure engine speed may be used. It is also considered within the scope of the invention that any number of engine operating speeds may be used depending on the cooling requirements of vehicle components 50. In accordance with an embodiment of the invention, second predetermined engine operating speed is preferably larger than first predetermined engine operating speed.

It is considered within the scope of the invention, that first vehicle system component 46 and second vehicle system component 48 may be any vehicle system disposed within vehicle system 1, such as inverter 22 or AC motor 24. It is also considered within the scope of the invention that controller input 44 may be communicated with a plurality of vehicle components 50 so as to allow controller 40 to receive a plurality of vehicle system temperature signals. It is understood that the first temperature signal T₁ and second temperature signal T₂ may be compared to a number of threshold values to determine the appropriate engine speed. In addition, alternate conditions may be established depending on whether one or both of first temperature signal T₁ and second temperature signal T₂ exceed a respective threshold. In accordance with an embodiment of the invention, the invention may be applied to vehicles other than locomotives.

In an exemplary embodiment, the method of FIG. 2 is utilized when the locomotive vehicle system 1 is operated in dynamic braking mode. As noted above, in dynamic braking mode the engine speed is set based on locomotive vehicle system 1 cooling requirements. In accordance with an embodiment of the invention, the method of FIG. 2 may also be used in certain motoring modes when the locomotive is traveling at low speeds. Thus, the invention is not limited in application to braking modes.

In accordance with an embodiment of the invention, controller 40 may be any controller device known in the art and suitable to the desired end purpose. In addition, controller 40 preferably includes processing circuitry having a microprocessor or equivalent component capable of processing the method of the invention.

In accordance with an embodiment of the invention, predetermined temperature threshold value may be stored via any suitable storage method known in the art and suitable to the desired end purpose, such as electronically erasable programmable read only memory (EEPROM).

Processing of FIG. 2 may be implemented through a controller 40 operating in response to a computer program. In order to perform the prescribed functions and desired processing, as well as the computations therefore (e.g., the execution of voltage mode motor control algorithm(s), the control processes prescribed herein, and the like), the controller may include, but not be limited to, a processor(s), computer(s), memory, storage, register(s), timing, interrupt(s), communication interfaces, and input/output signal interfaces, as well as combinations comprising at least one of the foregoing. For example, the controller may include signal input signal filtering to enable accurate sampling and conversion or acquisitions of such signals from communications interfaces.

As described above, the present invention can be embodied in the form of computer-implemented processes and apparatuses for practicing those processes. The present invention can also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Existing vehicles having reprogrammable storage (e.g., flash memory) can be updated to implement the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

It will be understood that a person skilled in the art may make modifications to the preferred embodiment shown herein within the scope and intent of the claims. While the present invention has been described as carried out in a specific embodiment thereof, it is not intended to be limited thereby but is intended to cover the invention broadly within the scope and spirit of the claims.

What is claimed is:

1. A system for cooling a vehicle by controlling the engine speed of a vehicle comprising:
a vehicle system, wherein said vehicle system includes a vehicle system component, an engine having an engine speed, an alternator and a blower having a blower speed; and
a controller, wherein said controller is communicated with said engine so as to control said engine speed and wherein said controller is communicated with said vehicle system component so as to be responsive to the temperature of said vehicle system component.

2. The system of claim 1, wherein said blower is communicated with said engine through said alternator such that said blower speed is responsive to said engine speed.

3. The system of claim 1, wherein said vehicle system further includes an auxiliary winding set and an induction motor, wherein said alternator is communicated with said engine and said auxiliary winding set and wherein said auxiliary winding set is communicated with said induction motor.

4. The system of claim 3, wherein said blower is communicated with said induction motor such that said blower is communicated with said engine through said induction motor, said auxiliary winding set and said alternator.

5. The system of claim 1, wherein said vehicle system further includes a field excitation control device, wherein said field excitation control device is communicated with said alternator.

6. The system of claim 1, wherein said vehicle system further includes a rectifying device, an inverter and an AC traction motor, wherein said rectifying device is communicated with said alternator and said inverter and wherein said inverter is communicated with said AC traction motor.

7. The system of claim 1, wherein said vehicle system component is an AC traction motor.

8. The system of claim 1, wherein said vehicle system component is an inverter.

9. The system of claim 1, wherein said alternator is communicated with said engine such that said alternator is driven by said engine.

10. The system of claim 1, wherein said vehicle system includes an auxiliary winding set wherein said auxiliary winding set is communicated with said alternator such that said auxiliary winding set is driven by said alternator.

11. The system of claim 1, wherein said vehicle system includes an induction motor and an auxiliary winding set, wherein said induction motor is communicated with said auxiliary winding set such that said induction motor is driven by said auxiliary winding set.

12. The system of claim 1, wherein said controller includes a controller input communicated with said vehicle system component so as to receive a temperature signal from said vehicle system component.

13. The system of claim 12, wherein said controller performs a temperature comparison so as to compare said temperature signal with a temperature threshold value and wherein said controller adjusts said engine speed in a manner responsive to said temperature comparison.

14. The system of claim 1, wherein said controller includes a controller output, wherein said controller output is communicated with said engine so as to allow said controller to control said engine speed, in a manner responsive to the temperature of said vehicle system component.

15. The system of claim 1, wherein said controller includes a processing circuit having a microprocessor.

16. The system of claim 1, wherein said controller includes processing circuitry.

17. In a vehicle having a vehicle system which includes an engine having an engine speed, a blower having a blower speed, a vehicle component and a controller, wherein said controller is communicated with said engine such that said engine speed is responsive to said controller and wherein said engine is communicated with said blower such that said blower speed is responsive to said engine speed, a method for cooling said vehicle by controlling said engine speed of said vehicle comprising:
operating said vehicle system so as to cause said engine and said blower to operate;
communicating a temperature signal from said vehicle component to said controller;
comparing said temperature signal with a predetermined temperature threshold value so as to determine if said temperature signal exceeds said predetermined temperature threshold value; and
controlling said engine so as to cause said engine to operate at a predetermined engine operating speed.

18. The method of claim 17, wherein operating said vehicle system includes operating said engine so as to cause the temperature of said vehicle component to increase.

19. The method of claim 17, wherein said vehicle component is an AC traction motor.

20. The method of claim 17, wherein said vehicle component is an inverter.

21. The method of claim 17, wherein said communicating a temperature signal includes communicating a temperature signal to said controller, wherein said temperature signal is responsive to said vehicle component.

22. The method of claim 17, wherein said communicating a temperature signal includes communicating a temperature signal to said controller, wherein said temperature signal is responsive to the ambient environment surrounding said vehicle component.

23. The method of claim 17, wherein said temperature signal includes a first temperature signal and a second temperature signal and wherein said predetermined temperature threshold value includes a first temperature threshold value and a second temperature threshold value.

24. The method of claim 23, wherein said comparing said temperature signal includes comparing said first temperature signal with said first temperature threshold value.

25. The method of claim 23, wherein said comparing said temperature signal includes comparing said second temperature signal with said second temperature threshold value.

26. The method of claim 17, wherein said predetermined engine operating speed includes a first predetermined engine operating speed and a second predetermined engine operating speed, wherein said first predetermined engine operating speed includes a first predetermined number of revolutions per minute (RPM) and said second predetermined engine operating speed includes a second predetermined number of revolutions per minute (RPM).

27. The method of claim 26, wherein said controlling said engine includes controlling said engine so as to cause said engine to operate at said first predetermined engine operating speed.

28. The method of claim 26, wherein said controlling said engine includes controlling said engine so as to cause said engine to operate at said second predetermined engine operating speed.

29. In a vehicle having a vehicle system which includes an engine having an engine speed, a blower having a blower speed, a vehicle component and a controller, wherein said controller is communicated with said engine such that said engine speed is responsive to said controller and wherein said engine is communicated with said blower such that said blower speed is responsive to said engine speed, a medium encoded with a machine-readable computer program code for cooling said vehicle by controlling said engine speed of said vehicle, said medium including instructions for causing controller to implement a method comprising:
receiving a temperature signal from said vehicle component;
comparing said temperature signal with a predetermined temperature threshold value so as to determine if said temperature signal exceeds said predetermined temperature threshold value; and
controlling said engine so as to cause said engine to operate at a predetermined engine operating speed.

30. The medium of claim 29, wherein said receiving a temperature signal includes receiving said temperature signal, wherein said temperature signal is responsive to said vehicle component.

31. The medium of claim 29, wherein said receiving a temperature signal includes receiving said temperature signal, wherein said temperature signal is responsive to the ambient environment surrounding said vehicle component.

32. The medium of claim 29, wherein said temperature signal includes a first temperature signal and a second temperature signal and wherein said predetermined temperature threshold value includes a first temperature threshold value and a second temperature threshold value.

33. The medium of claim 32, wherein said comparing said temperature signal includes comparing said first temperature signal with said first temperature threshold value.

34. The medium of claim 32, wherein said comparing said temperature signal includes comparing said second temperature signal with said second temperature threshold value.

35. The medium of claim 29, wherein said predetermined engine operating speed includes a first predetermined engine operating speed and a second predetermined engine operating speed, wherein said first predetermined engine operating speed includes a first predetermined number of revolutions per minute (RPM) and said second predetermined engine operating speed includes a second predetermined number of revolutions per minute (RPM).

36. The medium of claim 35, wherein said controlling said engine includes controlling said engine so as to cause said engine to operate at said first predetermined engine operating speed.

37. The medium of claim 35, wherein said controlling said engine includes controlling said engine so as to cause said engine to operate at said second predetermined engine operating speed.

38. A system for cooling a vehicle component by controlling the speed of operation of an engine powering the vehicle, the system comprising:
an engine operable at least at two different speeds of operation;
an electrical power generator driven by the engine and generating electrical power in an amount directly related to the speed of operation of the engine;
a blower for directing a flow of cooling air past the vehicle component to be cooled, with the blower being powered by the electrical power generator and operating at differing speeds of operation to deliver a varying a flow rate of cooling air past the components to be cooled in direct relation to the power provided by the generator;
a temperature sensor associated with the vehicle component providing a signal indicative of the temperature of the vehicle components; and
an engine speed controller responsive to the temperature signal to increase the speed of operation of the engine and thus the flow rate of cooling air past the vehicle component when the component temperature is above a predetermined level and to decrease the speed of operation of the engine when the component temperature falls below a predetermined level.
